(19) United States
(12) Patent Application Publication
(10) Pub. No.: US 2012/0006983 A1
(43) Pub. Date: Jan. 12, 2012

(54) METHOD OF SURFACE IONIZATION WITH SOLVENT SPRAY AND EXCITED-STATE NEUTRALS

(75) Inventor: Robert B. Cody, Portsmouth, NH (US)

(73) Assignee: Jeol USA Inc., Peabody, MA (US)

(21) Appl. No.: 13/258,094

(22) PCT Filed: May 17, 2010
(86) PCT No.: PCT/US10/35118

§ 371 Date: Sep. 21, 2011

Related U.S. Application Data
(60) Provisional application No. 61/179,195, filed on May 18, 2009.

(51) Int. Cl. H01J 49/10

(52) U.S. Cl. 250/282

(57) ABSTRACT

A method of producing analyte, analyte fragment, and/or analyte adduct ions for mass analysis comprises the steps of spraying a solvent at a surface bearing the analyte, directing desorbed analyte evolved from the surface into a region containing species which will ionize the analyte on collision, the ionizing region not including the surface bearing the analyte, and directing the ions formed in the ionizing region to the entrance to a mass analyzer.

### BACKGROUND OF THE INVENTION

1. Field of the Invention

This invention relates to atmospheric ionization of analytes with metastable atoms and molecules and like plasmas. Metastable atoms and molecules are excited-state species with long lifetimes. Metastable species are produced, for example, in corona or glow electrical discharges. Collisions between excited-state species and ground-state species can result in ionization.

Desorption can occur by simple evaporation or aided by heat or photons (photoflash or lasers) or direct exposure to a plasma. Desorption may be assisted with use of solvents sprayed on the surface. Solvents can be chosen to selectively extract certain materials from surfaces and solvent chemistry can be modified to enhance certain characteristics of analysis.

2. Description of Related Art

A metastable atom and molecule source is described in U.S. Pat. No. 6,949,741 and No. 7,112,785. The source has come to be known commercially as DART®. By directing the metastable species, ions, and electrons from the DART® source at a surface, analytes on the surface can be ionized, desorbed, and analyzed with a mass spectrometer or the like.

Known spray desorption methods include DESI (desorption electrospray ionization) and DESSI (desorption sonicspray ionization). These methods produce complex spectra that contain multiple charged ions for large and small molecules, multiple cation adducts [M+H]⁺, [M+NH₄]⁺, [M+Na]⁺, [M+K.]⁺, and are subject to sample suppression if analyte concentrations are high.

### SUMMARY OF THE INVENTION

Briefly, according to one embodiment of this invention, there is provided a method of producing analyte, analyte fragment, and/or analyte adduct ions for mass analysis comprising the steps of spraying a solvent at a surface bearing the analyte, directing desorbed analytes evolved from the surface into a region (volume) containing species which will ionize the analyte on collision, and directing the ions formed to the entrance to a mass analyzer. The ionizing region does not include the surface bearing the analyte.

According to a specific embodiment of this invention, there is provided a method of producing an analyte, analyte fragment, and/or analyte adduct ions for mass analysis comprising the steps of: introducing a carrier gas at atmospheric pressure into a chamber, establishing conditions in the chamber for creating metastable neutral excited-state species, spraying a solvent at a surface bearing the analyte, directing the carrier gas and metastable neutral excited-state species from the chamber through the desorbed analyte in a region (volume) not including the surface, and directing the ions formed in the ionizing region to the entrance to a mass analyzer.

### BRIEF DESCRIPTION OF THE DRAWINGS

Further features and other objects and advantages will become apparent from the following description of preferred embodiments of this invention made with reference to the drawings in which:

FIG. 1 illustrates a setup for practice of this invention with spraying of solvent directly at the surface being analyzed;

FIG. 2 illustrates a setup for practice of this invention with spraying of solvent directed to glance off the surface being analyzed;

FIG. 3 is a mass spectrum of epitestosterone detected according to the method of this invention; and

FIG. 4 is a diagram illustrating that the method for analyzing the analyted epitestosterone on a surface requires both solvent spray and the flow of carrier gas with neutral metastable species to form ions.

### DESCRIPTION OF THE PREFERRED EMBODIMENTS

Suitable apparatus for practice of this invention are disclosed in U.S. Pat. No. 6,949,741 and No. 7,112,785 and portions of those patents describing apparatus for creating neutral excited-state species are incorporated herein by reference.

FIG. 1 illustrates the physical relationship of the surface 1 bearing an analyte, a solvent sprayer 4, the neutral excited-state species source 2, and the inlet to a mass analyzer 3. As shown in FIG. 1, an aerosol spray is directed squarely at the surface bearing the analyte. The carrier gas and neutral excited-state species are directed across the space abutting the surface and through the desorbed analyte and toward the entrance to the mass analyzer. Note that the neutral excited-state species are not directed at the surface bearing the analyte itself.

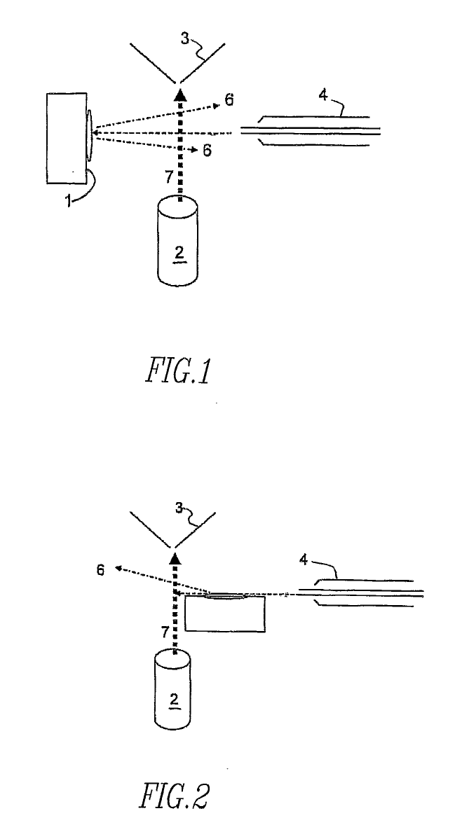

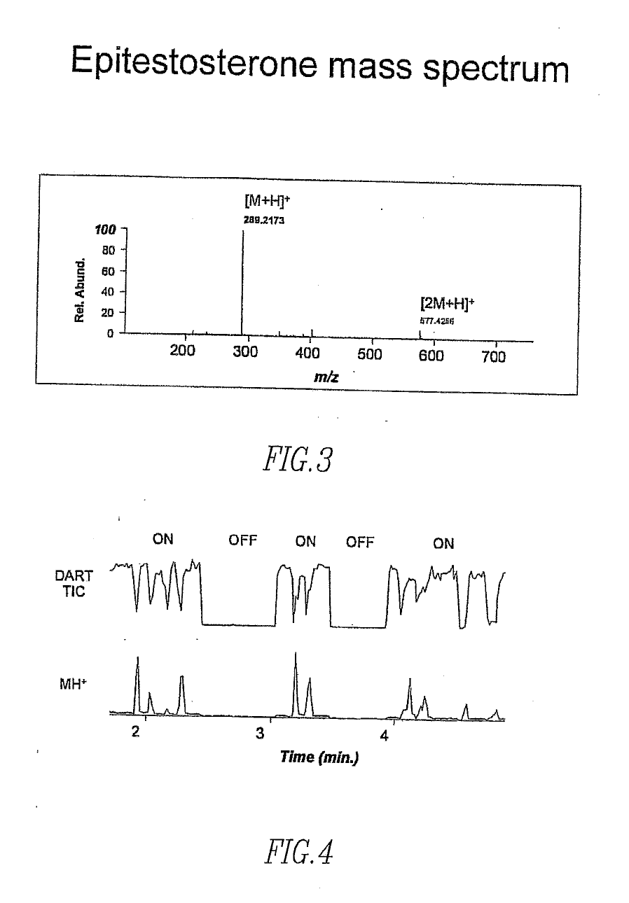

FIG. 2 illustrates another embodiment according to this invention. In this embodiment, an aerosol spray 6 is glanced across the surface of the specimen, and the carrier gas and neutral excited-state species 7 are directed through the desorbed analyte carried along in the spray beyond the surface.

A solvent spray or aerosol is directed toward a surface containing an analyte. The analyte is dissolved in the solvent which is then evolved to an ionizing region. In the ionizing region, collisions with excited-state neutrals from: (1) a DART® atmospheric pressure chemical ionization source, (2) flowing afterglow from an atmospheric glow discharge, (3) a dielectric barrier discharge, or (4) low-temperature plasma or the like will enable ionization of the desorbed analyte.

### EXAMPLE

Epitestosterone was brushed on the surface of a sheet of paper. Epitestosterone is not normally volatile. The surface was sprayed with a solvent with the arrangement shown in FIG. 2. The mass spectrum obtained was very clean showing only the [M+H]⁺ and [2M+H]⁺ peaks.

Referring to FIG. 4, in another experiment, the DART® source was turned on and off for intervals as shown. The top trace illustrates the total ion current (TIC) entering the mass analyzer during the ON times and none during the OFF times. The bottom trace illustrates the [M+H]⁺ detected during the ON interval. What is demonstrated is that this is not a simple solvent extraction or solvent sonic ionization technique.

It is an advantage according to this method that simpler mass spectra (free of multiple charges and [M+Na]⁺, [M+K.]⁺ adducts) are produced. Sample suppression at high analyte concentration is greatly reduced compared with other solvent spray methods.

Having thus described my invention with the detail and particularity required by the Patent Laws, what is desired protected by Letters Patent is set forth in the following claims.

1. A method of producing analyte, analyte fragment, and/or analyte adduct ions for mass analysis comprising the steps of:
spraying a solvent at a surface bearing the analyte;
directing desorbed analyte evolved from the surface into a region containing species which will ionize the analyte on collision, the ionizing region not including the surface bearing the analyte; and
directing the ions formed in the ionizing region to the entrance to a mass analyzer.

2. The method of claim 1, wherein the solvent is directed squarely at the surface.

3. The method according to claim 1, wherein the solvent is glanced across the surface.

4. The method according to claim 1, wherein the ionizing species is a metastable neutral excited-state species.

5. The method according to claim 4, wherein the metastable neutral exited-state species are created by an atmospheric pressure ionization source, a flowing afterglow from an atmospheric glow discharge, a dielectric barrier discharge, or a low-temperature plasma.

6. A method of producing analyte, analyte fragment, and/or analyte adduct ions for mass analysis comprising the steps of:
introducing a carrier gas at atmospheric pressure into a chamber;
establishing conditions in the chamber for creating metastable neutral excited-state species;
spraying a solvent at a surface bearing the analyte to desorb the analyte;
directing the carrier gas and metastable neutral excited-species from the chamber through the desorbed analyte in a region not including the surface; and
directing the ions formed at or near the surface to the entrance to a mass analyzer.

7. The method according to claim 6, wherein the solvent is directed squarely at the surface and the carrier gas and metastable neutral excited-state species are directed parallel to the surface.

8. The method according to claim 6, wherein the solvent is glanced across the surface and the carrier gas and metastable neutral excited-state species are directed perpendicular to the surface.

9. The method according to claim 6, wherein the neutral exited-state species are created by an atmospheric pressure ionization source, a flowing afterglow from an atmospheric glow discharge, a dielectric barrier discharge, or a low-temperature plasma.
